(19) United States
(12) Patent Application Publication
(10) Pub. No.: US 2008/0239998 A1
(43) Pub. Date: Oct. 2, 2008

(54) SIP COMMUNICATION SYSTEM, CALL CONTROL SERVER AND SIP COMMUNICATION METHOD

(76) Inventors: KENICHI OGAMI, Tokyo (JP); Yasuo Okamoto, Tokyo (JP); Hajime Komura, Tokyo (JP)

Correspondence Address: NEC CORPORATION OF AMERICA, 6535 N. STATE HWY 161, IRVING, TX, 75039, US

(21) Appl. No.: 12/049,697

(22) Filed: Mar. 17, 2008

(30) Foreign Application Priority Data
Mar. 27, 2007 (JP) 81420/2007

(51) Int. Cl. H04L 12/16

(52) U.S. Cl. 370/265

(57) ABSTRACT

There is provided a SIP communication system or the like which, by performing SIP communication between a terminal and a call control server, performs position registration or calling control of the terminal and provides one or multiple supplementary services for an incoming/outgoing call in accordance with subscriber information managed by a home subscriber server, wherein the call control server is provided with supplementary service function sections for providing the multiple supplementary services, respectively, and a service management section for causing the services of the multiple supplementary service function sections to be distributed and executed while managing conflicts.

This application is based upon and claims the benefit of priority from Japanese Patent Application No. 2007-081420, filed on Mar. 27, 2007, the disclosure of which is incorporated herein in its entirety by reference.

### BACKGROUND OF THE INVENTION

1. Field of the Invention

The present invention relates to a SIP (Session Initiation Protocol) communication system which, by performing SIP communication between a terminal and a call control server, performs position registration or calling control of the terminal and provides one or multiple supplementary services for an incoming/outgoing call in accordance with subscriber information managed by a home subscriber server, the call control server, and a SIP communication method.

2. Description of the Related Art

The VoIP (Voice over IP) service for performing voice communication on an IP (Internet Protocol) network has gathered attention because more inexpensive system construction is possible in comparison with the conventional public switched telephone network (PSTN) using a circuit switched network, from the viewpoint of operation, accounting and the like.

Furthermore, there have been proposed and developed techniques and standards for integrating mobile communication systems such as a mobile phone, and various communication networks such as a public wireless LAN (Local Area Network) and a public switched telephone network, with a central focus on the VoIP technology to construct a next-generation network.

As an example of this kind of next-generation network architecture, for example, IMS (IP Multimedia Subsystem) by 3GPP (3rd Generation Partnership Project) is known (for example, 3GPP IP Multimedia Subsystem (IMS): http://www.3gpp.org/ftp/Specs/html-info/23228.htm).

Generally, in the VoIP communication system described above, when a call is made, a called terminal is identified by SIP between a calling terminal and a call control server to mediate connection between both terminals.

Though SIP techniques which are almost based on the specifications proposed by RFC3261 and the like have been already put to practical use in each of current VoIP services, there is also proposed a configuration using a SIP message having a further extended header for a communication system considered to be a next-generation network, such as the IMS described above (for example, IMS call control protocol based on SIP and SDP: http://www.3gpp.org/ftp/Specs/html-info/24229.htm; and RFC3455 3GPP SIP extended header: http://www.ietf.org/rfc/rfc3455.txt).

In the VoIP/SIP based communication technology described above, a server in charge of a particular communication function, such as a SIP server (call control server), a DNS server and an ENUM server, is considered to be a server with a single function. In the actual use, these servers are installed and operated as stand-alone apparatuses.

On the other hand, the communication system considered to be a next-generation network, such as the IMS described above, is required to support various supplementary communication services. Such communication services include, for example, caller's number notification, caller's number display, anonymous incoming call rejection, incoming call rejection, voice communication transfer and nuisance call rejection. In general, an AS (application server) in charge of these various communication services is also considered to be such that is to be installed as a stand-alone server with a single function.

When the call control server receives a call, communication between the call control server and the AS is naturally required in order to provide supplementary communication services to be enjoyed by the subscriber on the calling side or the called side in accordance with his contract. In the notification and rejection services among the above communication services, communication between the AS and the call control server is required in all call connections irrespective of whether the services are used or not.

FIG. 6 shows a conventional position registration sequence in the IMS and FIGS. 7 and 8 show examples of a conventional call connection sequence.

In FIGS. 6 to 8, a CSCF (Call Session Control Function) is a call control server in the IMS, and it mediates an incoming/outgoing call between a SIP terminal 1 and a SIP terminal 2 with the use of SIP, similarly to a so-called SIP server conventionally used. Generally, a CSCF is installed for each communication line carrier with which a subscriber (SIP terminal 1) is signed up.

Each of an AS1 and an AS2 indicates an application server which provides one of the above supplementary services. Though only two AS's are shown for simplification here, more AS's are actually installed depending on the number of supplementary services.

An HSS (Home Subscriber Server) in FIG. 6 is a database server which manages subscriber information, service information and the like. By communicating with the HSS, the call control server CSCF and the application servers AS1 and AS2 control incoming/outgoing calls, roaming incoming/outgoing calls and the like, and obtain information about whether there is any supplementary service to be provided and provide a supplementary service in accordance with a contract or a set supplementary service.

In the position registration (REGISTER) sequence in FIG. 6, when the SIP terminal 1 enters a service area, position registration is performed between the SIP terminal 1 and the CSCF (61). This is performed by SIP (ISC), by SIP messages REGISTER and OK (the message ID is generally 200) being exchanged.

In response to this, subscriber information and information about supplementary services are exchanged between the CSCF and the HSS (62). Since this sequence is related to user information such as a user ID and a telephone number, an authentication protocol such as the Diameter protocol (RFC3588 Diameter Base Protocol: http://www.ietf.org/rfc/rfc3588.txt) is used. In the case of the Diameter protocol, this sequence (62) for exchanging subscriber information and information about supplementary services is performed by exchanging SAR/SAA messages (Diameter Cx interface).

The CSCF communicates with the AS1 and the AS2 with the use of a SIP REGISTER message in order to activate a necessary supplementary service (63 and 65).

In response to this, each of the AS1 and the AS2 refers to the HSS to determine whether or not to provide the supplementary service or to make aspect settings (64 and 66). Here, information about the supplementary service is given and received by exchanging UDR/UDA messages of the Diameter protocol (Diameter Sh interface).

As for the call connection sequence shown in FIGS. 7 and 8 also, it is required to perform a complicated sequence when the AS1 and the AS2 providing a supplementary service intervene. That is, as shown in FIGS. 7 and 8, in the processing for connecting the SIP terminal 1 and the SIP terminal 2, with a CSCF intervening between them (giving and receiving of an INVITE message, ringing, response with an ACK message denoted by reference numerals 71, 72 and 73) or disconnection processing (by a BYE message denoted by reference numeral 75) after communication (74), the CSCF exchanges the same SIP message with each of the AS1 and the AS2.

As shown above, according to the conventional technical idea that AS's in charge of supplementary services to be supported are configured as stand-alone apparatuses, it is necessary to install more AS's as the number of supplementary services to be supported increases. Accordingly, it becomes necessary to install AS hardware individually and secure the number of network nodes (IP addresses) corresponding to the number of pieces of AS hardware.

Furthermore, when accepting a call, a call control server has to communicate with a lot of AS's. Therefore, increase in network delay and in network load is caused, and moreover, there is a possibility that the efficiency, quickness and real-time nature of the calling processing by the call control server is impaired. Furthermore, when a delay is caused due to the network topology, the performance of each server or the like, there may be caused a problem that communication between the call control server and AS's cannot be normally performed because of timing difference, and it becomes impossible to provide particular supplementary communication services for users in an extreme case.

That is, the conventional idea of installing a stand-alone AS (application server) for each service can respond to the situation where the number of communication services to be provided is small. However, there is a possibility that it cannot sufficiently respond to the future communication environment in which the supplementary services are anticipated to be diversified.

### SUMMARY OF THE INVENTION

An exemplary object of the invention is to enable highly reliable SIP communication to be performed even when a lot of supplementary services are provided, by appropriately arranging the communication functions of AS's (application servers) and a call control server in a SIP communication system.

An exemplary aspect of the invention includes a SIP communication system which, by performing SIP communication between a terminal and a call control server, performs position registration or calling control of the terminal and provides one or multiple supplementary services for an incoming/outgoing call in accordance with subscriber information managed by a home subscriber server, the call control server and a SIP communication method, wherein the call control server is provided with supplementary service function sections for providing the multiple supplementary services, respectively, and a service management section for causing the services of the multiple supplementary service function sections to be distributed and executed while managing conflicts; in the case of performing position registration of the terminal, the call control server makes settings for each of the supplementary service function sections with the use of subscriber information obtained from the home subscriber server; and, in the case of performing the calling control, by the service management section of the call control server causing the supplementary services of the multiple supplementary service function sections to be distributed and executed for the incoming/outgoing call while managing conflicts among the supplementary services, the supplementary services are provided by the supplementary service function sections of the call control server.

According to the above configuration, since a configuration is used in which the functions of AS's (application servers) are integrated in a call control server, the necessity of installing a lot of AS's outside so as to correspond to multiple supplementary services, respectively, is eliminated. The problems of increase in the number of nodes and the number of apparatuses to be installed, exhaustion of addresses, network delay, network load and the like do not occur, and highly reliable SIP communication is enabled even in the case of providing a lot of supplementary services. Furthermore, since there is provided service management means for causing the call control server to distribute and execute the services of multiple supplementary service sections while managing conflicts, an excellent advantage is obtained that it is possible to provide appropriate supplementary services depending on subscriber information without occurrence of conflicts.

### BRIEF DESCRIPTION OF THE DRAWINGS

FIG. 1 is a diagram showing the functional block configuration of a call control server adopting an exemplary embodiment of the present invention;

FIG. 2 is a flowchart showing the state of calling control by the call control server adopting the exemplary embodiment of the present invention;

FIG. 3 is a diagram showing the state of a position registration sequence in the call control server adopting the exemplary embodiment of the present invention;

FIG. 4 is a diagram showing the state of a calling control sequence in the call control server adopting the exemplary embodiment of the present invention;

FIG. 5 is a block diagram showing the configuration of the control system of the call control server adopting the exemplary embodiment of the present invention;

FIG. 6 is a diagram showing the state of a position registration sequence in a conventional call control server;

FIG. 7 is a diagram showing the state of a calling control sequence in the conventional call control server; and

FIG. 8 is a diagram showing the state of the calling control sequence in the conventional call control server (continued from FIG. 7).

### DETAILED DESCRIPTION OF THE PREFERRED EMBODIMENTS

A call control server (CSCF) for controlling incoming/outgoing calls of SIP communication will be described below as an exemplary embodiment of the present invention with reference to drawings.

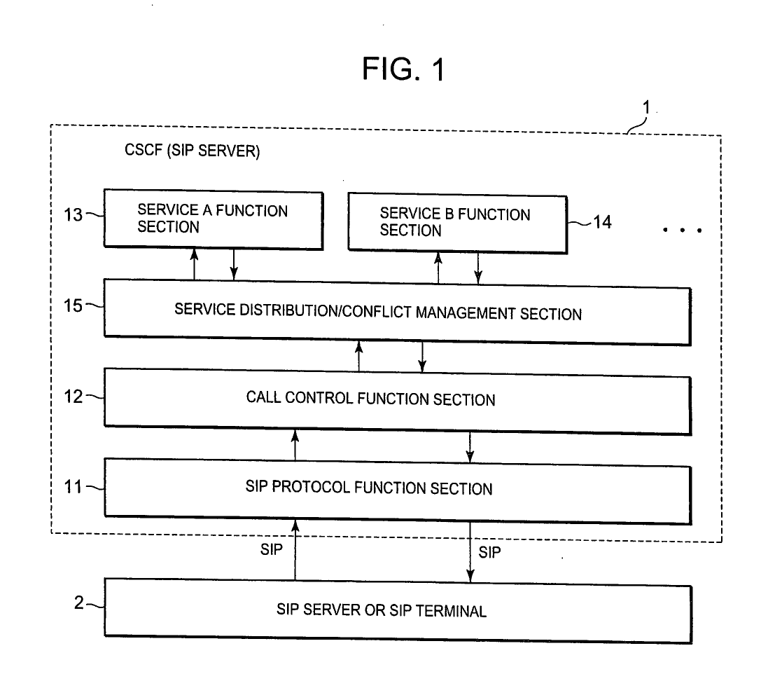

FIG. 1 shows the outline of the functional configuration of a call control server 1 adopting the present invention.

In FIG. 1, the call control server 1 is configured as a SIP server which functions as a CSCF in the IMS network described above.

The main characteristic of the call control server 1 of this embodiment is that the functions of AS's (application servers) which have been conventionally installed as different stand-alone apparatuses are integrated in this call control server 1.

That is, the call control server 1 in FIG. 1 includes a SIP protocol function section 11 which performs encoding/decoding of SIP signals transmitted to and received from an IP network, a call control function section 12 which controls a SIP session, a Diameter protocol function section 16 which performs encoding/decoding of a Diameter signal for communicating with an HSS.

The SIP protocol function section 11 and the call control function section 12 control incoming/outgoing calls by SIP, which is the main function of a CSCF. That is, the SIP protocol function section 11 and the call control function section 12 constitute SIP control means for controlling SIP communication, which is the main function of a SIP server.

Furthermore, in this embodiment, supplementary service function sections 13, 14, . . . are integrated in the call control server 1 so that one or multiple supplementary services which have been conventionally provided by different application servers (AS's) can be provided.

Each of the supplementary service function sections 13, 14, . . . provides any of the above-described supplementary services such as caller's number notification, caller's number display, anonymous incoming call rejection, incoming call rejection, voice communication transfer and nuisance call rejection, and one supplementary service function section is provided for each supplementary service to be provided. At the time of performing calling processing, one or multiple supplementary services of the supplementary service function sections 13, 14, . . . are provided in accordance with subscriber information obtained from the HSS.

Furthermore, the call control server 1 of this embodiment is provided with a service distribution/conflict management section 15 which functions as service management means for performing distribution/conflict management of the multiple supplementary services provided by the supplementary service function sections 13, 14, . . . . By providing this service distribution/conflict management section 15, it is possible to distribute supplementary services which different stand-alone AS's have conventionally been responsible for and have exclusively controlled, to the supplementary service function sections 13, 14, . . . and provide them, without conflicts among them with the call control server 1.

The SIP protocol function section 11 and the call control function section 12 which are the main functions of the CSCF internally exchange information about setting and execution of the supplementary services performed via SIP communication, with the supplementary service function sections 13, 14, . . . corresponding to conventional AS's (application servers), respectively, as the SIP communication progresses.

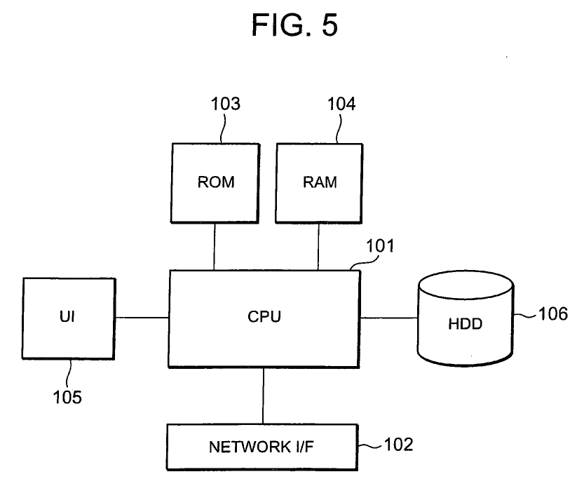

That is, the information exchange between the SIP protocol function section 11 and the call control function section 12 constituting the SIP control means and the supplementary service function sections 13, 14, . . . can be performed by message exchange by any predetermined method via an internal bus included in hardware (FIG. 5) to be described later.

However, a configuration is possible, of course, in which execution of the supplementary services is controlled by a software process realizing the SIP protocol function section 11 and the call control function section 12 corresponding to the main functions of the SIP server and a software process realizing the supplementary service function sections 13, 14, . . . mutually performing SIP communication with the IP address/SIP port number of the apparatus as the destination. However, since the supplementary service function sections 13, 14, . . . are integrated in the call control server, it is more desirable to perform the information exchange between the SIP protocol function section 11 and the call control function section 12, and the supplementary service function sections 13, 14, . . . not via SIP communication but through a more efficient internal procedure.

As described above, in the call control server of this embodiment, the functions of stand-alone AS's (application servers) which have been conventionally arranged outside the apparatus are integrated as the supplementary service function sections 13, 14, . . . . Accordingly, in a SIP communication system using the call control server of this embodiment, it is not necessary to install AS's outside if the supplementary service function sections 13, 14, . . . supporting intended supplementary services are provided in the call control server.

In FIG. 1, reference numeral 2 denotes another SIP node, for example, another SIP server or SIP terminal.

The hardware of the call control server 1 is configured, for example, as shown in FIG. 5.

In FIG. 5, the call control server 1 is constituted by a CPU 101 as main control means, a network interface 102 used as an interface with an IP network on which the call control server 1 is arranged, a ROM 103 in which the control program of the CPU 101 and constants required for control are stored, a RAM 104 used as a work area, user interface means 105 configured by a keyboard, a display and the like used for setting, management and maintenance of the apparatus.

In addition, the call control server 1 may be also provided with an HDD 106 for storing control information required for call control and other necessary applications as necessary.

In FIG. 1 again, the function sections 11 to 13 of the call control server 1 are actually control means realized by the CPU 101 in FIG. 5 controlling each hardware in the figure in accordance with a control procedure to be described later. The control procedure described later is stored in the ROM 103 (or the HDD 106 or the like) as the control program of the CPU 101.

Especially, by constituting the supplementary service function sections 13, 14, . . . of this embodiment by software, an advantage can be obtained that addition of or change in supplementary services to be provided can be arbitrarily performed with high flexibility.

Furthermore, the service distribution/conflict management section 15 which performs distribution/conflict management of the supplementary services of the supplementary service function sections 13, 14, . . . can be easily configured by software.

Especially in the example described later, supplementary services to be provided by the multiple the supplementary service function sections 13, 14, . . . for each subscriber are registered with the service distribution/conflict management section 15 in advance with priorities attached thereto, and control is performed so that the supplementary services are sequentially executed in order of priorities while conflicts being avoided.

It goes without saying that one skilled in the art can constitute any part of each function section in FIG. 1 by dedicated hardware depending on designing conditions, requested performance, and the like.

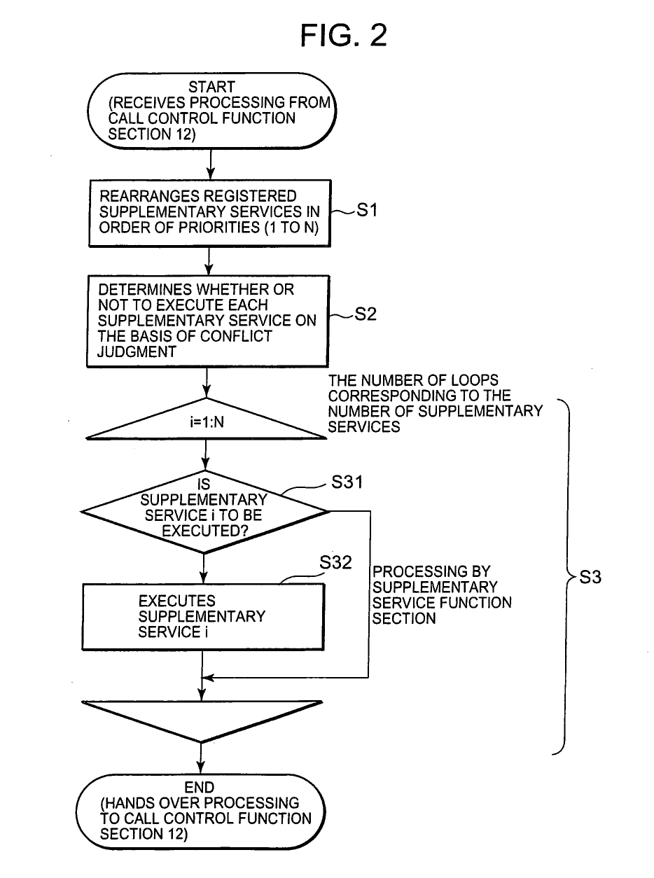

FIG. 2 shows a control flow in the case of providing various supplementary service services by the supplementary service function sections 13, 14, . . . . The control shown in the figure is especially described as processing performed in the case where the call control function section 12 detects a call from the SIP terminal 2. However, it goes without saying that, in the case of sequentially performing registration processing of supplementary services at the time of position registration or the like, equal conflict/distribution processing can be also performed.

When the call control function section 12 detects a call from the SIP terminal 2, at step S1 in FIG. 2, the supplementary service function sections 13, 14, . . . registered in order of priorities for the subscriber rearrange the supplementary services (1 to N) to be processed in the order of priorities.

At step S2, conflict judgment is performed by the service distribution/conflict management section 15 to determine whether or not to execute each supplementary service. For example, for each of the supplementary services, a flag indicating whether or not to execute the service is set, and it is stored at a predetermined address so as to be referred to by the loop shown below.

Then, at the loop at step 3, the registered supplementary services 1 to N are sequentially executed. Here, an index (variable) i specifying a supplementary service is gradually incremented within the range of 1 to N. and each supplementary service is specified by the value of the index i.

First, at step S31, it is determined whether or not to execute the supplementary service. This judgment can be performed, for example, by referring to the flag indicating whether or not to execute a supplementary service set at step S2, for the supplementary service specified by the index i.

In the case of executing the supplementary service specified by the index i at step S31, any of the supplementary service function sections 13, 14, . . . corresponding to the supplementary service is controlled to provide the supplementary service at step S32.

In the case of not executing the supplementary service specified by the index i at step S31, the index i is incremented, and the flow proceeds to processing of the next supplementary service. When all the supplementary services (1 to N) have been processed, the control is handed over to the call processing by the call control function section 12.

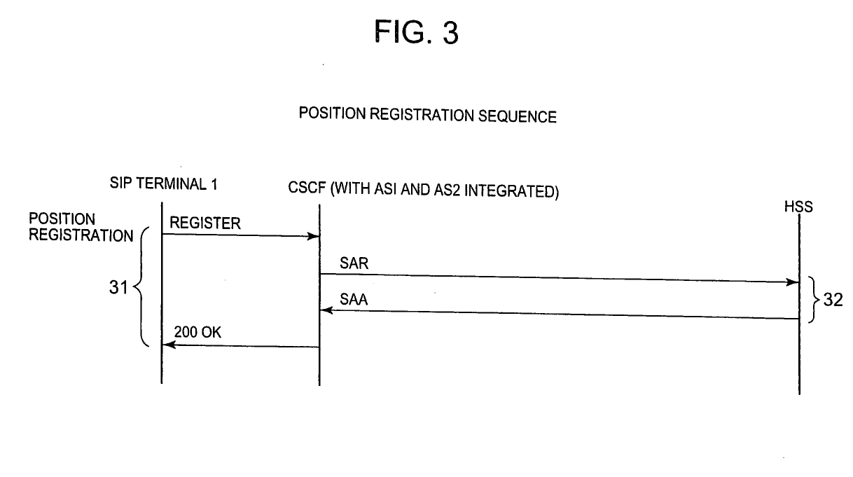

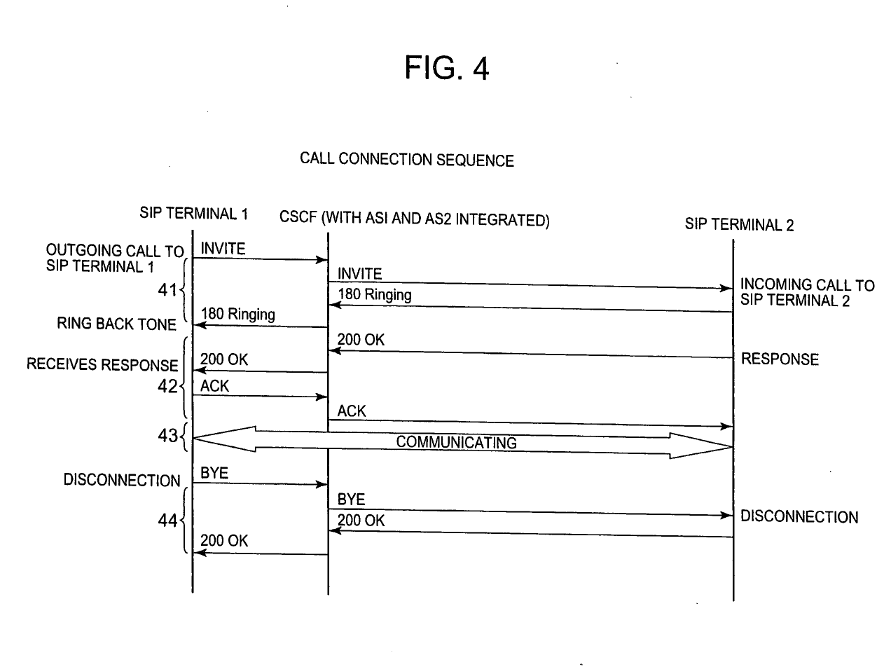

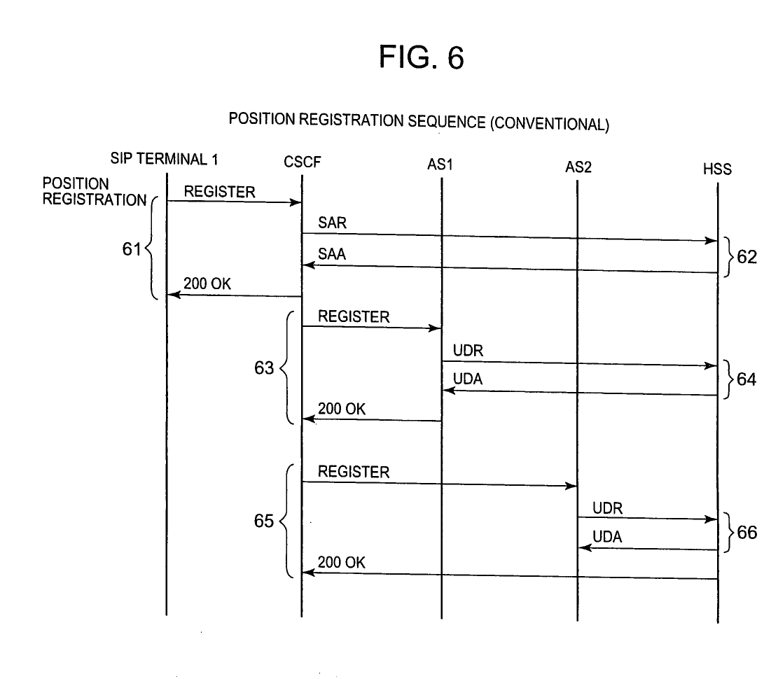

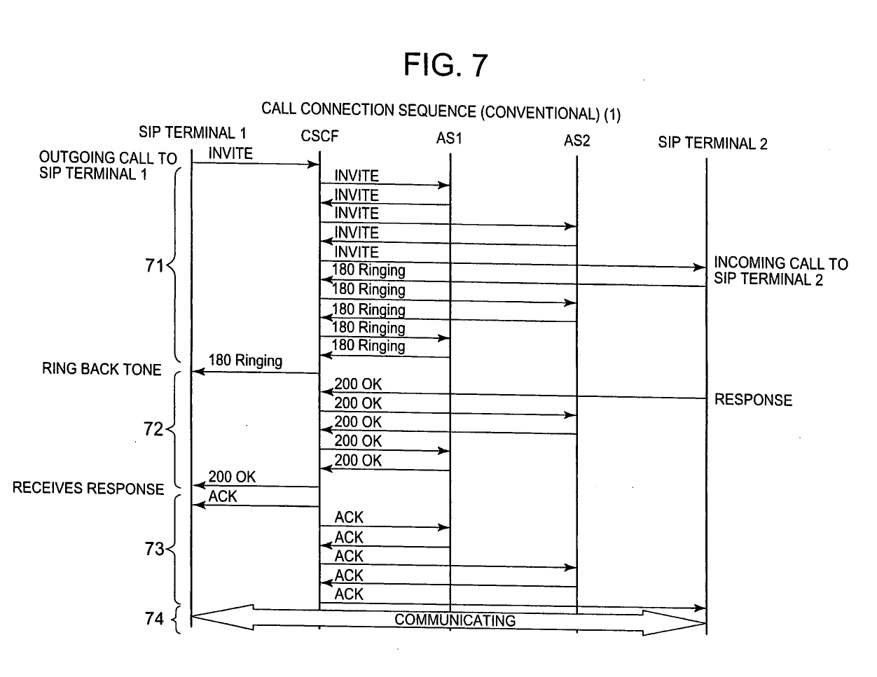

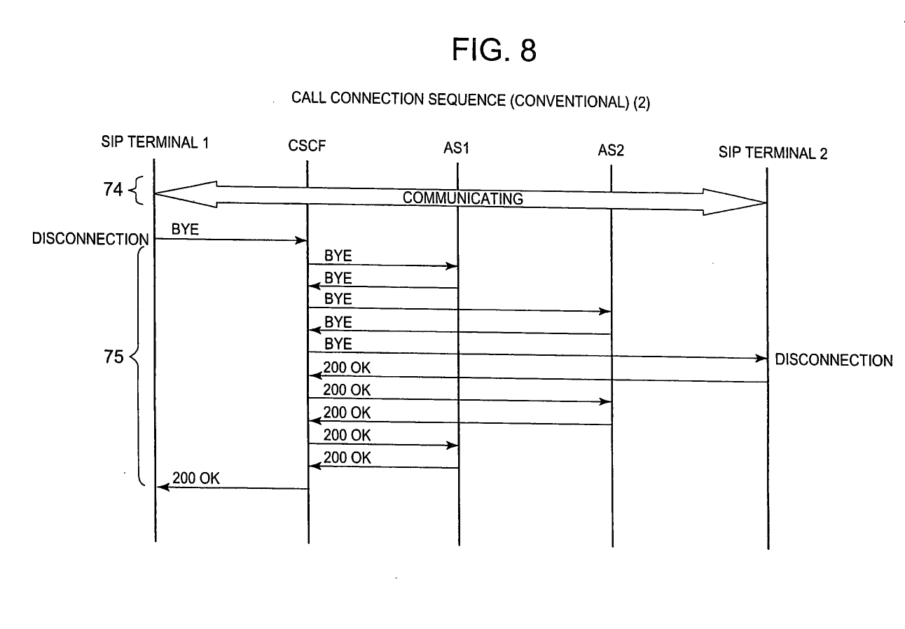

FIG. 3 shows a position registration sequence by the call control server of this embodiment, and FIG. 4 shows an example of a calling control sequence by the call control server. FIG. 3 corresponds to the sequence in FIG. 6 of the conventional example, and FIG. 4 corresponds to the sequence in FIGS. 7 and 8 of the conventional example.

In FIGS. 3 and 4, the CSCF is the call control server described in FIGS. 1 and 2, and the functions of the application servers AS1 and AS2 of the conventional example are integrated therein as the supplementary service function sections 13 and 14. This call control server CSCF mediates an incoming/outgoing call between the SIP terminal 1 and the SIP terminal 2 with the use of SIP.

The HSS (Home Subscriber Server) in FIG. 3 is a database server which manages subscriber information and service information similar to those in the conventional example. By communicating with the HSS, the call control server CSCF in FIG. 3 in which the functions of the application servers AS1 and AS2 are integrated controls incoming/outgoing calls, roaming incoming/outgoing calls and the like, and obtains information about whether there is any supplementary service to be provided and provides a supplementary service in accordance with a contract or a set supplementary service.

As apparently seen from comparison with the position registration sequence in FIG. 6, the position registration sequence in FIG. 3 does not require communication performed between the CSCF and the AS1 and AS2 (by SIP) and communication performed between the AS1 and AS2, and the HSS (Diameter Sh interface).

At the time of performing the position registration in FIG. 3, the CSCF and the HSS performs information exchange for subscriber information and information about supplementary services (31) via communication using the Diameter Cx interface (giving and receiving of SAR/SAA messages).

Communication between the HSS and the AS1, AS2, . . . , which has been conventionally performed via the Diameter Sh interface is not required. By making settings for the supplementary service function sections 13, 14, . . . with the use of the information obtained from the information exchange between the HSS for the subscriber information and the supplementary services (31), settings for supplementary services to be made at the time of position registration have been made. In this case, the information exchange between the SIP protocol function section 11 and the call-control function section 12, and the supplementary service function sections 13, 14, . . . can be performed not via SIP communication but through a more efficient internal procedure.

As apparently seen from comparison with the conventional calling control sequence in FIGS. 7 and 8, in the calling control sequence in FIG. 4, provision of supplementary services does not have to be performed while SIP communication with an external AS is performed for each service, as have been conventionally done, in each of the sequences of INVITE, ringing (41), response (42) and disconnection after communication (43), and they can be directly provided by the supplementary service function sections 13, 14, . . . of the call control server CSCF appropriately set.

As shown above, according to this embodiment, since a configuration is used in which the functions of AS's (application servers) are integrated in a call control server, the necessity of installing a lot of AS's outside so as to correspond to multiple supplementary services, respectively, is eliminated. The problems of increase in the number of nodes and the number of apparatuses to be installed, exhaustion of addresses, network delay, network load and the like do not occur, and highly reliable SIP communication is enabled even in the case of providing more supplementary services. Furthermore, since the call control server is provided with a service distribution/conflict management section as service management means for distributing and executing the services of multiple supplementary service function sections while managing conflicts, it is possible to provide appropriate supplementary services according to subscriber information without occurrence of conflicts.

That is, according to this embodiment, by appropriately arranging the communication functions of AS's (application servers) and a call control server, highly reliable SIP communication can be performed even in the case of providing multiple supplementary services.

Furthermore, in a communication system using the call control server of this embodiment, though at least communication by the Diameter Cx interface is required for communication with an HSS, communication between AS's and the HSS by the Diameter Sh interface is not required. Therefore, as for information exchange for registration and setting of supplementary services, communication between the call control server of this embodiment and the HSS can be limited to the communication via the Diameter Cx interface.

Furthermore, in the communication system using the call control server of this embodiment, SIP communication between the call control server and AS's (application servers), which has been conventionally required, is not required, and supplementary services can be provided by the supplementary service function sections 13, 14, . . . integrated in the call control server.

As for a communication interface with the outside, the call control server of this embodiment is required to be provided with the Diameter protocol function section 16 in comparison with the conventional call control server. However, this Diameter protocol function section 16 can be configured relatively inexpensively because it is sufficient if the Diameter protocol function section 16 supports the Diameter Cx interface for communicating an HSS.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A SIP communication system which, by performing SIP communication between a terminal and a call control server, performs position registration or calling control of the terminal and provides one or multiple supplementary services for an incoming/outgoing call in accordance with subscriber information managed by a home subscriber server, wherein
the call control server is provided with supplementary service function sections for providing the multiple supplementary services, respectively, and a service manager to cause the services of the multiple supplementary service function sections to be distributed and executed while managing conflicts;
in the case of performing position registration of the terminal, the call control server makes settings for each of the supplementary service function sections with the use of subscriber information obtained from the home subscriber server; and
in the case of performing calling control, by the service manager of the call control server causing the supplementary services of the multiple supplementary service function sections to be distributed and executed for the incoming/outgoing call while managing conflicts among the supplementary services, the supplementary services are provided by the supplementary service function sections of the call control server.

2. The SIP communication system according to claim 1, wherein the call control server is provided with a Diameter protocol function section for communicating with the home subscriber server by the Diameter protocol; and in the case of performing position registration of the terminal, the call control server communicates with the home subscriber server via a Diameter protocol Cx interface by the Diameter protocol function section to obtain subscriber information from the home subscriber server.

3. The SIP communication system according to claim 1, wherein information exchange between a SIP controller to control SIP communication of the call control server and the supplementary service function sections is performed via message exchange in a predetermined method via an internal bus of the call control server.

4. A call control server for performing position registration or calling control of a terminal by performing SIP communication with the terminal, the call control server comprising:
supplementary service function sections for providing one or multiple supplementary services for an incoming/outgoing call according to subscriber information managed by a home subscriber server; and
a service manager to cause the services of the multiple supplementary service sections to be distributed and executed while managing conflicts; wherein
in the case of performing position registration of the terminal, the call control server makes settings for each of the supplementary service function sections with the use of subscriber information obtained from the home subscriber server; and
in the case of performing the calling control, by the service manager causing the supplementary services of the multiple supplementary service function sections to be distributed and executed for the incoming/outgoing call while managing conflicts among the supplementary services, the supplementary services of the supplementary service function sections are provided.

5. The call control server according to claim 4, comprising a Diameter protocol function section for communicating with the home subscriber server by the Diameter protocol, wherein, in the case of performing position registration of the terminal, communication is performed with the home subscriber server via a Diameter protocol Cx interface by the Diameter protocol function section to obtain subscriber information from the home subscriber server.

6. The call control server according to claim 4, wherein information exchange between a SIP controller to control SIP communication with the terminal and the supplementary service function sections is performed via message exchange in a predetermined method via an internal bus.

7. A SIP communication method in which, by performing SIP communication between a terminal and a call control server, position registration or calling control of the terminal is performed and one or multiple supplementary services for an incoming/outgoing call are provided in accordance with subscriber information managed by a home subscriber server, wherein
supplementary service function sections for providing the multiple supplementary services, respectively, and a service manager to cause the services of the multiple supplementary service function sections to be distributed and executed while managing conflicts, which are provided in the call control server, are used;
in the case of performing position registration of the terminal, the call control server makes settings for each of the supplementary service function sections with the use of subscriber information obtained from the home subscriber server; and
in the case of performing the calling control, by the service manager of the call control server causing the supplementary services of the multiple supplementary service function sections to be distributed and executed while managing conflicts among the supplementary services, the supplementary services are provided by the supplementary service function sections of the call control server.

8. The SIP communication method according to claim 7, wherein a Diameter protocol function section for communicating with the home subscriber server by the Diameter protocol, which is provided in the call control server, is used; and in the case of performing position registration of the terminal, the call control server communicates with the home subscriber server via a Diameter protocol Cx interface by the Diameter protocol function section to obtain subscriber information from the home subscriber server.

9. The SIP communication method according to claim 7, wherein information exchange between a SIP controller to control SIP communication of the call control server and the supplementary service function sections is performed via message exchange in a predetermined method via an internal bus of the call control server.
